(19) United States
(12) Patent Application Publication
(10) Pub. No.: US 2014/0294420 A1
(43) Pub. Date: Oct. 2, 2014

(54) IMAGE FORMING APPARATUS

(71) Applicant: SAMSUNG ELECTRONICS CO., LTD., Suwon-si (KR)

(72) Inventor: Han Jun Lee, Goyang-si (KR)

(73) Assignee: SAMSUNG ELECTRONICS CO., LTD., Suwon-si (KR)

(21) Appl. No.: 14/225,955

(22) Filed: Mar. 26, 2014

(30) Foreign Application Priority Data
Mar. 26, 2013 (KR) 10-2013-0032129

(51) Int. Cl. G03G 15/00

(52) U.S. Cl. CPC G03G 21/0005
USPC 399/74

(57) ABSTRACT

An image forming apparatus is provided. The image forming apparatus includes a sensing unit configured to check a transfer belt, which serves to transfer a visible image to a printing medium, the image forming apparatus capable of reducing contamination of sensors since a lighting window of a sensor provided in the sensing unit is open and closed by a shutter and a shutter driving device.

### CROSS-REFERENCE TO RELATED APPLICATIONS

This application is related to, and claims priority to, Korean Patent Application No. 10-2013-0032129, filed on Mar. 26, 2013 in the Korean Intellectual Property Office, the disclosure of which is incorporated herein by reference.

### BACKGROUND

1. Field

Embodiments of the present disclosure relate to an image forming apparatus having a sensing unit configured to check a toner on a transfer belt.

2. Description of the Related Art

In general, an image forming apparatus is an apparatus that may form an image on a printing medium. Types of image forming apparatus include a printer, a copy machine, a facsimile, and a multifunctional device having the functionalities of two or more of the printer, the copy machine, and the facsimile.

An image forming apparatus includes a body provided at one side thereof with an opening, and a side cover rotatably installed at the body to open and close the opening. The body may be provided at an inside thereof with a plurality of developing units to develop electrostatic latent images to visible images through toners according to colors, an exposure device to form an electrostatic latent image on a photoconductor of each of the developing units by irradiating light onto the photoconductor of the developing units, a transfer device to transfer the visible image developed on the photoconductor to the printing medium, and a fusing device to fix the toner to the printing medium.

The transfer device includes a transfer belt to receive a toner from the plurality of developing units to transfer the toner to the printing medium. A sensing unit may be disposed at a lower side of one portion of the transfer belt to check the toner on the transfer belt.

The sensing unit includes a sensor formed using an optical sensor. Since the sensing unit may be disposed at a lower side of the transfer belt, the toner may cover the sensor, resulting in contamination of the sensor. Accordingly, in order to obtain a constant image quality, a user needs to regularly clean the sensor.

### SUMMARY

It is an aspect of the present disclosure to provide an image forming apparatus capable of extending a cleaning period of the sensor that is configured to check a toner on the transfer belt.

Additional aspects of the disclosure will be set forth in part in the description which follows and, in part, will be obvious from the description, or may be learned by practice of the disclosure.

In accordance with an embodiment of the present disclosure, an image forming apparatus includes a plurality of developing units, a transfer belt and a sensing unit. The plurality of developing units may be configured to develop electrostatic latent images to visible images through toners. The transfer belt may be configured to transfer the visible image developed by the developing unit to a printing medium. The sensing unit may be configured to check the toner being transferred on the transfer belt, while being disposed opposite to the transfer belt. The sensing unit may include at least one sensor disposed opposite to the transfer belt, a sensor housing to accommodate the at least one sensor, and a shutter installed at the sensor housing so as to be moveable in a width direction of the transfer belt to open and close a lighting window provided at the at least one sensor.

The image forming apparatus may include a shutter driving device configured to drive the shutter. The shutter driving device may include a driving motor to generate a rotating force, a worm rotated by the driving motor, a worm wheel teethed with the worm, and a lever rotated by a rotation of the worm wheel. The worm wheel may be provided at one side surface thereof with a cam part. The lever may be rotated by receiving a force through the cam part so as to move the shutter in a first direction.

The sensing unit may include a shutter spring configured to elastically support the shutter in a second direction opposite to the first direction.

The worm wheel may be provided at an other side surface thereof with a sensed part that has an arc shape and extends in a circumferential direction of the worm wheel. The shutter driving device may include a position detecting sensor to sense the sensed part.

The shutter may include a protrusion part protruding from the sensor housing outwards. The lever may include a support part supported by the cam part, and a pressing part to apply force to the protrusion part by being locked with the protrusion part.

The shutter driving device may include a lever spring to elastically support the lever to return the lever to an original position of the lever.

The at least one sensor may include a plurality of sensors disposed while being spaced apart from one another in a width direction of the transfer belt. The shutter may include a plurality of through-holes corresponding to light windows of the plurality of sensors, respectively.

The sensing unit may be disposed at a lower side of the transfer belt.

The image forming apparatus may include a body configured to accommodate the plurality of developing units and the transfer belt. The body may include an opening formed at one side thereof, a side cover to open and close the opening, and a body frame that is disposed at a lower portion of inside the opening and on which the sensing unit is installed. The lever may be rotatably installed at the body frame.

In accordance with an aspect of the present disclosure, an image forming apparatus includes a plurality of developing units, a transfer belt, a sensing unit, and a shutter driving device. The plurality of developing units may be configured to develop electrostatic latent images to visible images through toners. The transfer belt may be configured to transfer the visible image developed by the developing units to a printing medium. The sensing unit may be configured to check the toner being transferred on the transfer belt, while being disposed opposite to the transfer belt. The shutter driving device may be configured to drive a shutter provided at the sensing unit. The sensing unit may include at least one sensor disposed opposite to the transfer belt, a sensor housing to accommodate the at least one sensor, and the shutter movably installed at the sensor housing to open and close a lighting window provided at the at least one sensor. The shutter driving device may include a driving motor to generate a rotating force.

In a case in which the toner on the transfer belt is checked through a sensing unit, a shutter may be moved to open a lighting window of the sensor. In a case in which the toner on the transfer belt is not checked, the lighting window of the sensor may be kept in closed by the shutter, thereby reducing contamination of the sensor and extending the cleaning period of the sensor.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates an image forming apparatus in accordance with an embodiment of the present disclosure.

FIG. 2 illustrates an exemplary sensing unit and a shutter driving device in an image forming apparatus in accordance with an embodiment of the present disclosure.

FIG. 3 is an exploded view illustrating an exemplary sensing unit and a shutter driving device in an image forming apparatus in accordance with an embodiment of the present disclosure.

FIG. 4 illustrates an exemplary state of a lighting window of a sensor opened by a shutter in an image forming apparatus in accordance with an embodiment of the present disclosure.

FIG. 5 illustrates an exemplary state of a lighting window of a sensor closed in an image forming apparatus in accordance with an embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

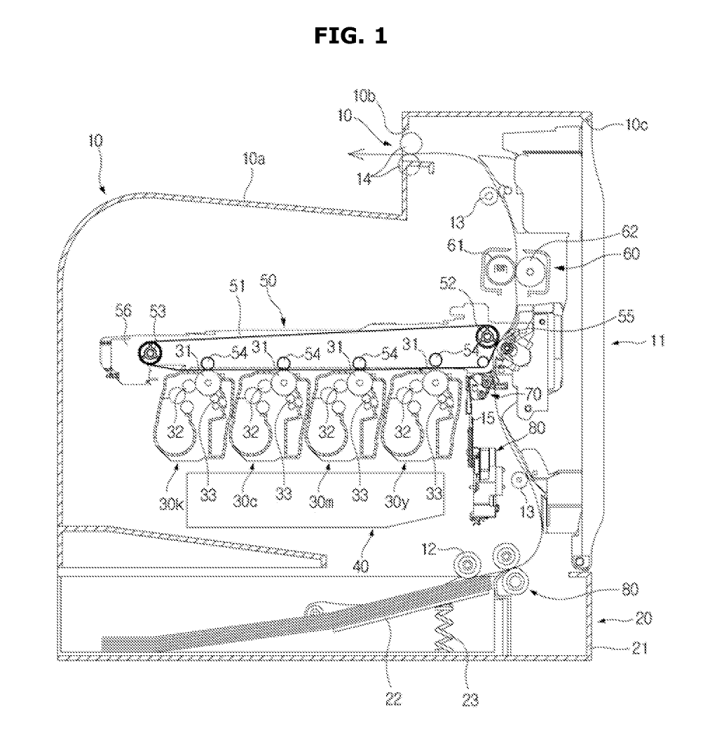

As illustrated in FIG. 1, an image forming apparatus in accordance with an embodiment of the present disclosure includes a body 10 forming the external appearance of the image forming apparatus, a printing medium storage unit 20 to store printing medium, a plurality of developing units 30C, 30M, 30Y and 30K to develop electrostatic latent images to visible images according to colors by use of toner, an exposure unit 40 to form electrostatic latent images by irradiating light onto photoconductors 31 of the charged developing units 30C, 30M and 30Y and 30K, a transfer device 50 to transfer the visible image formed on the photoconductors 31 to the printing medium, which is being delivered from the printing medium storage unit 20, a fusing unit 60 to fix the toner, which is transferred on the printing medium, to the printing medium, and a sensing unit 70 to check the toner on a transfer belt 51 of the transfer device 50.

The body 10 may be provided at an upper portion thereof with a loading part 10a on which the printing medium completed with the image formation is loaded. A discharge port 10b may be provided at one side of the loading part 10a to allow the printing medium completed with the image formation to be discharged therethrough. The body 10 may be provided at one side thereof with an opening 10c to repair components or replace expendable materials of an inside the body 10A side cover 11 having a lower end rotatably may be installed at the body 10 so as to open and close the opening 10c while rotating on the lower end thereof.

The printing medium storage unit 20 includes a printing medium cassette 21 movably installed at the body 10, a knock-up plate 22 to load the printing media while being disposed in the printing medium cassette 21, and a knock up spring 23 to elastically support the knock-up plate 22.

Each of the developing units 30C, 30M, 30Y and 30K includes a photoconductor 31, on a charged surface of which an electrostatic latent image is formed by the exposure unit 40, a developing roller 32 to supply toner to the photoconductor 31, and a charging unit 33 to charge the surface of the photoconductor 31.

The developing units 30C, 30M, 30Y and 30K in accordance with the embodiment of the present disclosure include four developing units 30C, 30M, 30Y and 30K each storing one of toners of cyan C, magenta M, yellow Y and black K at an inside thereof, to develop one of cyan C, magenta M, yellow Y and black K colors. The four developing units 30C, 30M, 30Y and 30K may be disposed at a lower portion of the transfer device 50 side by side.

The exposure unit 40 forms the electrostatic latent images on the surfaces of the photoconductors 31 by irradiating light including image information to the photoconductors 31 provided at the developing units 30C, 30M, 30Y and 30K, respectively.

The transfer device 50 includes a transfer belt 51 on which visible images developed on the photoconductors 31 of the developing units 30C, 30M, 30Y and 30k are transferred in an overlapping manner, a driving roller 52 and a driven roller 53 disposed at opposite sides of inside the transfer belt 51 to rotate the transfer belt 51, a plurality of first transfer rollers 54 disposed opposite to the photoconductors 31 of the developing units 30C, 30M, 30Y and 30K, respectively, while interposing the transfer belt 51 therebetween, such that the visible images formed on the photoconductors 31 are transferred to the transfer belt 51, and a transfer device frame 56 on which both ends of each of the first transfer rollers 54, the driving rollers 52 and the driven rollers 53 are rotatably installed.

A second transfer roller 55 may be disposed at the side cover opposite to the driving roller 52 while interposing the transfer belt 51 therebetween, to press the printing medium toward the transfer belt 51 to transfer the visible image of the transfer belt 51 to the printing media. Accordingly, the transfer belt 51 serves to transfer the visible image, formed of toner, which is transferred from the developing unit 30, on the printing medium.

The fusing unit 60 includes a heating roller 61 to generate heat, and a pressing roller 62, an outer circumferential surface of which may be formed of elastically deformable material to press the printing medium onto an outer circumferential surface of the heating roller 61.

At the body 10, a pick-up roller 12 may be disposed at an upper side of the printing medium storage unit 20 to pick up the printing media loaded on the knock-up plate 22, for example, one by one. A delivery roller 13 may guide the printing medium, which is picked up by the pick-up roller 12, for example, upward. A discharge roller 14 may be disposed at an upper side of the fusing unit 60 while being adjacent to the discharge port 10b to allow the printing medium passing through the fusing unit 60 to be discharged through the discharge port 10b.

The body 10 may be provided at an inside thereof with frames configured to install and support various elements. The frames include a body frame 14, which may be disposed at a lower portion of an inner side of the opening 10c and on which the sensing unit 70 may be installed.

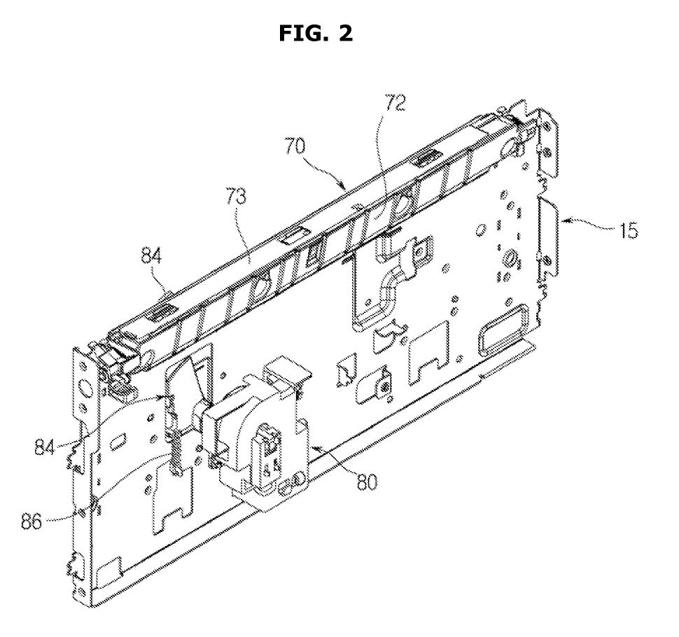

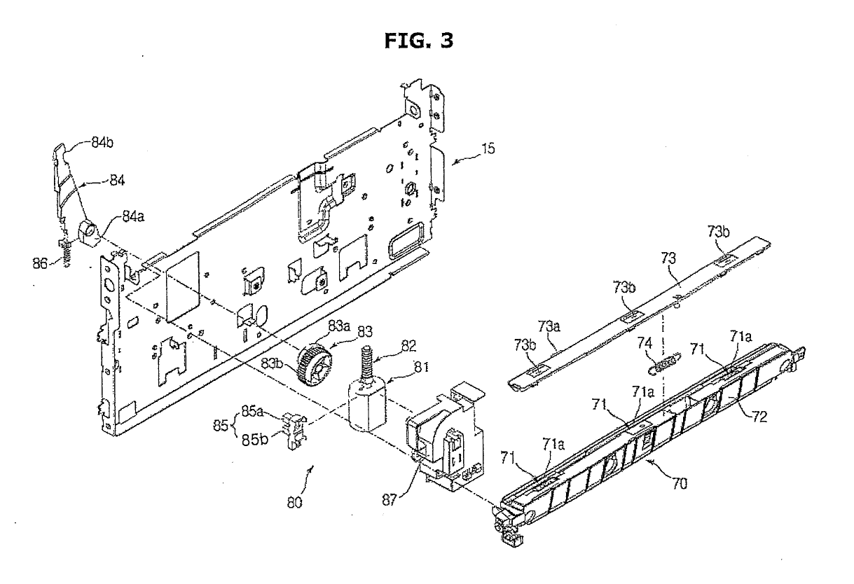

As illustrated in FIGS. 2 and 3, the sensing unit 70 may be disposed at a lower side of the transfer belt 51, and includes a plurality of sensors 71 that may be disposed opposite to a lower surface of the transfer belt 51 to check the toner on the transfer belt 51, a sensor housing 72 to accommodate the plurality of sensors 71 while allowing the plurality of sensors 71 to be installed therein, and a shutter 73 installed at the sensor housing 72 so as to be moveable, for example, in a width direction of the transfer belt 51 to open and close upper portions of the sensors 71. The sensors 71 in accordance with an exemplary embodiment of the present disclosure include three sensors 71 disposed while being spaced apart from one another, for example, in a width direction of the transfer belt 51. The shutter 73 includes three penetration parts 73b corresponding to the three sensors 71, respectively. The shutter 73 includes a protrusion part 73a protruding from the sensor housing 72 outwards to receive force from a lever 84.

The sensor 71 includes an optical sensor, and although not shown, the sensor 71 may be provided at an inside thereof with a light emitting part and a light receiving part. A lighting window 71a allowing light to pass therethrough may be provided at a surface facing the transfer belt 51 (an upper surface of the sensor 71 according to an embodiment of the present disclosure).

Accordingly, in a case when a toner on the transfer belt 51 does not need to be checked, the lighting window 71 a of the senor 71 may be kept closed while being covered by the shutter, and in a case when a toner on the transfer belt 51 needs to be checked, the lighting window 71a may be open by moving the shutter 73.

A shutter driving device 80 may be installed at the body frame 15 to move the shutter 73. The shutter driving device 80 includes a driving motor 81 to generate a rotating force, a worm 82 rotated by the driving motor 81, a worm wheel 83 rotated by rotation of the worm 82 while teethed with the worm 82, and a lever 84 rotatably installed at the body frame 15 and rotated by a rotation of the worm wheel 83 to move the shutter 73 in a first direction. A lever spring 86 may elastically support the lever 84 such that a support part 84a of the lever 84 is kept in a state of being supported by a cam part 83a of the worm wheel 83. A rotation position detecting sensor 85 may sense a rotating position of the worm wheel 83. A driving case 87 may be included to accommodate components of the shutter driving device 80.

The worm wheel 83 may be provided at one side surface thereof with the cam part 83a so as to press the lever 84 according to a rotation of the worm wheel 83 such that the lever 84 is rotated, and at the other side surface thereof with a sensed part 83b that allows the rotation angle of the worm wheel 83 to be sensed by the rotation position detecting sensor 85. The sensed part 83b may be provided in an arc shape extending in a circumferential direction of the worm wheel 83.

The lever 84 includes the support part 84a extending downward and supported by an outer circumferential surface of the cam part 83a, and a protrusion part 84b extending upward and locked with the protrusion part 73a of the shutter 73. The lever 84 presses the protrusion part 73a while rotating according to the rotation of the worm wheel 83, such that the shutter 73 is moved in the first direction.

The sensing unit 70 includes a shutter spring 74 to elastically support the shutter 73 such that the shutter 73 is moved in a second direction opposite to the first direction. The shutter spring 74 in accordance with an embodiment of the present disclosure may be formed using a coil spring having one end connected to the sensor housing 72 and the other end connected to the shutter 73.

The rotation position detecting sensor 85 may be formed using an optical sensor including a light emitting part 85a and a light receiving part 85b. The sensed part 83b blocks light, which is transmitted from the light emitting part 85a to the light receiving part 85b, while passing through an area between the light emitting part 85a and the light receiving part 85b depending on the rotation angle of the worm wheel 83. Accordingly, a position of the cam part 83a and the position of the lever 84 may be recognized. That is, based on whether the sensed part 83b is between the light emitting part 85a and the light receiving part 85b, a first setting angle of the worm wheel 83, corresponding to a state in which the lighting window 71 a of the sensor 71, is closed by the shutter 73, and a second setting angle of the worm wheel 83, representing a position at which the penetration part 73b of the shutter 73, corresponds to the sensor 71.

An exemplary operation of the image forming apparatus in accordance with an embodiment of the present disclosure is described with reference to the accompanied drawings in detail.

In a case in which the toner on the transfer belt 51 does not need to be checked, for example, the lighting window 71 a of the sensor 71 may be kept in a state of being closed by the shutter 73.

In this state, even if the toner is scattered on the transfer belt 51, the toner is not delivered to the sensor 71 but is covered only on the shutter 73, thereby preventing the sensor 71 from being contaminated.

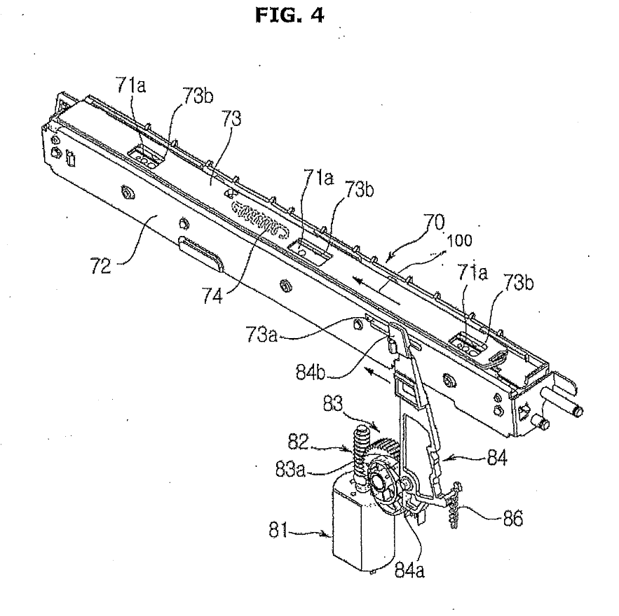

As illustrated in FIG. 4, in a case in which the toner on the transfer belt 51 needs to be checked, the worm 82 and the worm wheel 83 may be rotated by operating the driving motor 81. According to the rotation of the worm wheel 83, the cam part 83a provided at the worm wheel 83 moves the support part 84a of the lever 84, for example, toward an outside in a radial direction of the worm wheel 83. Accordingly, the lever 84 may be rotated, for example, counterclockwise as illustrated in FIG. 4, for example. According to the rotation of the lever 84, the pressing part 84b applies force to the shutter 73 through the protrusion part 73a such that the shutter 73 is moved in a first direction 100. According to the movement of the shutter 73, for example, the penetration parts 73b provided at the shutter 73 move to positions corresponding to the sensors 71, respectively, thereby causing the lighting windows 71 of the sensors 71 to be open.

Rotation of the worm wheel 83 at the second setting angle may be sensed depending on whether the sensed part 83b is located between the light emitting part 85a and the light receiving part 85b of the rotation position detecting sensor 85. If the rotation position detecting sensor 85 senses that the worm wheel 83 is rotated, for example, at a first setting angle, the operation of the driving motor 81 stops.

The rotations of the worm 82 and the worm wheel 83 stop as the operation of the driving motor 81 stops, in which the cam part 83a continues to push the support part 84a of the lever 84 toward an outside in the radial direction of the worm wheel 83 and thus the shutter 73 remains moved in the first direction. Accordingly, the lighting window 71a of the sensor 71 is kept open.

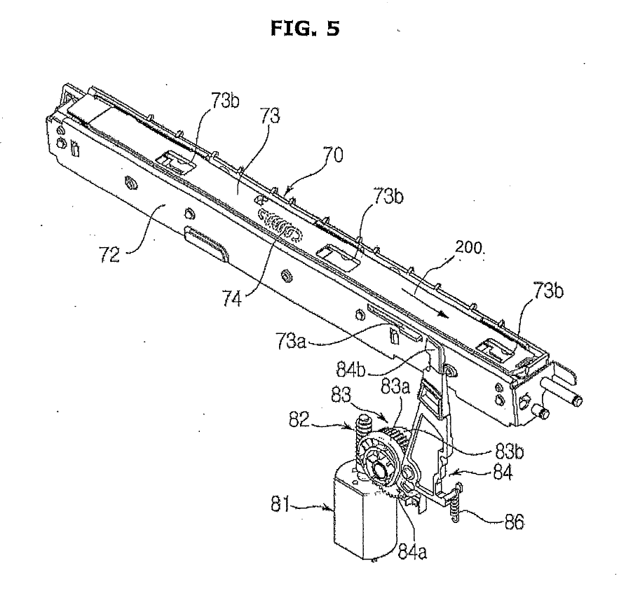

After the checking of the toner on the transfer belt 51 is completed, the driving motor 81 operates to rotate the worm 82 and the worm wheel 83. The support part 84a, which was moved toward the outside in the radial direction of the worm wheel 83 by the cam part 83a according to the rotation of the worm wheel 83, may be moved toward an inside in the radial direction of the worm wheel 83, for example, through the elastic restoring force of the lever spring 86, and thus the lever 84 may be rotated, for example, clockwise. As illustrated in FIG. 5, according to the rotation of the lever 84, the pressing part 84b of the lever 84 becomes distant from the protrusion part 73a in a direction opposite to the protrusion part 73a. The shutter 73, which may be elastically supported by the shutter spring 74 , is moved in a second direction 200 by the elastic restoring force of the shutter spring 74, as illustrated in FIG. 5, for example. According to the movement of the shutter 73 in the second direction, the penetration part 73b provided at the shutter 73 may be moved, for example, to a position at which the penetration part 73b does not correspond to the sensor 71, thereby causing the lighting window 71 a of the sensor 71 to be closed by the shutter 73, for example, as illustrated in FIG. 5.

In this state, if sensed, for example, by the rotation position detecting sensor 85 that the worm wheel 83 is rotated at the first setting angle, the operation of the driving motor 81 may stop.

Since the lighting window 71 a of the sensor 71 is open only when the toner on the transfer belt 51 is checked, the contamination of the sensor 71 is reduced and thus a cleaning period of the sensor 71 may be extended.

Although the shutter driving device 80 in accordance with an exemplary embodiment of the present disclosure is illustrated as transmitting power to the lever 84 through the worm 82 and the worm wheel 83, the present disclosure is not limited thereto. Transmitting power through a different scheme may used.

Although a few exemplary embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. An image forming apparatus comprising:
a transfer belt configured to transfer a visible image developed by a developing unit to a printing medium; and
a sensing unit configured to check the toner being transferred on the transfer belt, while being disposed opposite to the transfer belt,
wherein the sensing unit comprises at least one sensor disposed opposite to the transfer belt, a sensor housing to accommodate the at least one sensor, and a shutter installed at the sensor housing so as to be moveable in a width direction of the transfer belt to open and close a lighting window provided at the at least one sensor.

2. The image forming apparatus of claim 1, further comprising:
a shutter driving device configured to drive the shutter,
wherein the shutter driving device comprises a driving motor to generate a rotating force, a worm rotated by the driving motor, a worm wheel teethed with the worm, and a lever rotated by a rotation of the worm wheel, and
wherein the worm wheel is provided at one side surface thereof with a cam part, and
the lever is rotated by receiving a force through the cam part so as to move the shutter in a first direction.

3. The image forming apparatus of claim 2, wherein the sensing unit comprises a shutter spring configured to elastically support the shutter in a second direction opposite to the first direction.

4. The image forming apparatus of claim 2, wherein:
the worm wheel is provided at an other side surface thereof with a sensed part that has an arc shape and extends in a circumferential direction of the worm wheel; and
the shutter driving device comprises a position detecting sensor to sense the sensed part.

5. The image forming apparatus of claim 2, wherein:
the shutter comprises a protrusion part protruding from the sensor housing outwards; and
the lever comprises a support part supported by the cam part, and a pressing part to apply force to the protrusion part by being locked with the protrusion part.

6. The image forming apparatus of claim 5, wherein the shutter driving device further comprises a lever spring to elastically support the lever to return the lever to an original position of the lever.

7. The image forming apparatus of claim 1, wherein:
the at least one sensor comprises a plurality of sensors disposed while being spaced apart from one another in a width direction of the transfer belt; and
the shutter comprises a plurality of through-holes corresponding to light windows of the plurality of sensors, respectively.

8. The image forming apparatus of claim 2, wherein the sensing unit is disposed at a lower side of the transfer belt.

9. The image forming apparatus of claim 8, further comprising:
a body configured to accommodate the plurality of developing units and the transfer belt,
wherein the body comprises an opening formed at one side thereof, a side cover to open and close the opening, and a body frame which is disposed at a lower portion of inside the opening and on which the sensing unit is installed; and
the lever is rotatably installed at the body frame.

10. An image forming apparatus comprising:
a transfer belt configured to transfer a visible image developed by a developing unit to a printing medium;
a sensing unit configured to check the toner being transferred on the transfer belt, while being disposed opposite to the transfer belt; and
a shutter driving device configured to drive a shutter provided at the sensing unit,
wherein the sensing unit comprises at least one sensor disposed opposite to the transfer belt, a sensor housing to accommodate the at least one sensor, and the shutter movably installed at the sensor housing to open and close a lighting window provided at the at least one sensor, and
wherein the shutter driving device comprises a driving motor to generate a rotating force.

11. The image forming apparatus of claim 10, wherein the shutter driving device comprises a worm rotated by the driving motor, a worm wheel teethed with the worm, and a lever rotated by a rotation of the worm wheel and configured to move the shutter in a first direction representing a width direction of the transfer belt.

12. The image forming apparatus of claim 11, wherein the shutter driving device comprises a shutter spring configured to elastically support the shutter in a second direction opposite to the first direction.

13. The image forming apparatus of claim 11, wherein the sensing unit comprises a plurality of sensors disposed while being spaced apart from one another in the width direction of the transfer belt to check the toner on the transfer belt, and a sensor housing to accommodate the plurality of sensors, and
wherein the shutter comprises a plurality of through-holes that are formed through the sensor housing while being spaced apart from one another in the width direction of the transfer belt and corresponding to light windows of the plurality of sensors, respectively.

14. The image forming apparatus of claim 13, wherein:
the shutter comprises a protrusion part protruding from the sensor housing outwards;
the worm wheel is provided at one side surface thereof with a cam part; and
the lever comprises a support part supported by the cam part, and a pressing part to apply force to the protrusion part by being locked with the protrusion part according to rotation of the lever.

15. The image forming apparatus of claim 14, wherein the shutter driving device further comprises a lever spring configured to maintain the support part of the lever in a state of being supported by the cam part.

16. The image forming apparatus of claim 14, wherein:
the worm wheel is provided at other side surface thereof with a sensed part that has an arc shape and extends in a circumferential direction of the worm wheel; and
the shutter driving device comprises a position detecting sensor to sense the sensed part.

17. A shutter for an image forming apparatus including a transfer belt and a sensor, the shutter comprising:
a movable portion to open and close a lighting window that is located between the transfer belt and the sensor; and
a driving device to move the movable portion.

18. A method for reducing contamination of a sensor of an image forming apparatus, the method comprising:
opening a lighting window that is located between a transfer belt of the image forming apparatus and the sensor upon the sensor checking a status of toner on the transfer belt; and
closing the lighting window upon the sensor not checking the status of the toner.
